(19) United States
(12) Patent Application Publication
(10) Pub. No.: US 2006/0188114 A1
(43) Pub. Date: Aug. 24, 2006

(54) Sound isolation cap

(75) Inventors: George Wong, Ottawa (CA); Noland Lewis, Belmont, CA (US)

Correspondence Address: HESLIN ROTHENBERG FARLEY & MESITI PC, 5 COLUMBIA CIRCLE, ALBANY, NY, 12203, US

(73) Assignee: National Research Council of Canada, Ottawa (CA)

(21) Appl. No.: 11/338,190

(22) Filed: Jan. 24, 2006

Related U.S. Application Data
(60) Provisional application No. 60/645,758, filed on Jan. 24, 2005.

(30) Foreign Application Priority Data
Apr. 12, 2005 (CA) 2,504,778

(51) Int. Cl. H04R 25/00

(52) U.S. Cl. 381/189

(57) ABSTRACT

A sound isolation cap for use with a sound level meter. The cap has a bore in which a plug snugly fits. The plug, in the open position, allows air to travel between the exterior of the cap and the cap's interior cavity. In the closed position, the plug prevents air from traveling between the exterior of the cap and the interior cavity. Air may travel between the interior cavity and the exterior of the cap by way of two passages. One passage connects the interior cavity with the bore while the other passage connects the bore with the exterior of the cap. When in use, the microphone of the sound level meter is inserted into the interior cavity.

### CROSS-REFERENCE TO RELATED APPLICATIONS

This application claims priority from U.S. Provisional Application No. 60/645,758, filed Jan. 24, 2005, entitled “Sound Isolation Cap,” and from Canadian application 2,504,778, filed Apr. 12, 2005. These applications are hereby incorporated herein by reference in their entirety.

### FIELD OF THE INVENTION

The present invention relates to the field of acoustics. More specifically, the present invention relates to a sound isolation cap or an acoustically shielding device for use with a signal receptor for a sound level meter.

### BACKGROUND TO THE INVENTION

It is well known that the performance of a conventional sound level meter such as microphone and associated electronic circuits may be affected by electromagnetic interference (EMI) which may be present in the area of interest as a result of electromagnetic radiation from various sources. Most of the existing sound level meters are affected by EMI. Conventionally, the presence of EMI is confirmed by taking sound level readings with both a non-shielded and a shielded sound level meter. The readings for both are then compared. If the difference of the two level readings does not decrease substantially, such as by 30 dB, then there is EMI interference at the location, and the sound level readings taken may not be reliable.

In order to counter the effect of such interference a sound-insulating cap was developed and is disclosed in U.S. Pat. No. 5,870,483. However it was found that the air vent hole in this cap provided resulted in poor sound isolation and negatively affected readings.

An additional point of concern relates to the microphones used by sound level meters. Typical conventional sound level meters have microphones equipped with diaphragm transducers. The diaphragms are sensitive to pressure changes. It is important therefore to ensure that no sudden pressure build-up or drop occurs during the insertion (mounting) or removal of a sound insulating device onto such a microphone.

Providing an air vent in the sound insulating device helps with this problem. However, this concern is in direct conflict with sound isolation as it has been found that an air vent may result in poor sound isolation.

It is therefore an object of the present invention to provide an electromagnetically transparent and acoustically shielding device, which provides better sound isolation while taking into account the pressure sensitivity of microphones.

### SUMMARY OF THE INVENTION

The present invention provides a sound isolation cap for use with a sound level meter. The cap has a bore in which a plug snugly fits. The plug, in the open position, allows air to travel between the exterior of the cap and the cap's interior cavity. In the closed position, the plug prevents air from traveling between the exterior of the cap and the interior cavity. Air may travel between the interior cavity and the exterior of the cap by way of two passages. One passage connects the interior cavity with the bore while the other passage connects the bore with the exterior of the cap. When in use, the microphone of the sound level meter is inserted into the interior cavity.

In one embodiment, the present invention provides an acoustically shielding device for a sound level meter having a microphone, the device comprising:
a body having an interior cavity and an exterior, said interior cavity being for snugly enveloping said microphone;
a bore in said body, said bore being adjacent to said interior cavity, said bore being non-intersecting with said interior cavity;
a first passage in said body for allowing air to travel between said exterior of said body and said bore;
a second passage in said body for allowing air to travel between said interior cavity and said bore; and
a plug for snugly fitting in said bore, said plug having an open position and a closed position
   wherein
in said open position, said plug allows air to travel between said interior cavity and said exterior of said body by way of said first and second passages;
in said closed position, said plug prevents air from traveling between said interior cavity and said exterior of said body.

In another aspect, the present invention provides a method of acoustically shielding a sound receptor of a sound level meter, the method comprising
a) providing an acoustically shielding device having an interior cavity;
b) actuating a plug on said device to create an air passage between said interior cavity and an exterior of said device;
c) inserting said sound receptor into said interior cavity and allowing air to escape from said interior cavity to said exterior by way of said air passage created in step b);
d) closing said air passage to thereby acoustically seal said sound receptor in said interior cavity.

### BRIEF DESCRIPTION OF THE DRAWINGS

A better understanding of the invention will be obtained by considering the detailed description below, with reference to the following drawings in which:

FIG. 1 is a side cut-away view of a sound isolation cap according to a first embodiment of the invention with the plug in the open position;

FIG. 2 is a side cut-away view of the sound isolation cap of FIG. 1 with the plug in the closed position;

FIG. 3 is a side cut-away view of a sound isolation cap according to a second embodiment of the invention with the plug in the closed position;

FIG. 4 is a side cut-away view of the sound isolation cap of FIG. 3 with the plug in the open position;

FIG. 5 is a side cut-away view of a sound isolation cap of according to a third embodiment of the invention with the plug in the closed position;

FIG. 6 is a side cut-away view of the sound isolation cap of FIG. 5 with the plug in the open position;

FIG. 7 is an isometric view of a sound isolation cap according to yet another embodiment of the invention; and

FIG. 8 is a side cut-away view of the sound isolation cap of FIG. 7 with the plug in the closed position.

### DETAILED DESCRIPTION

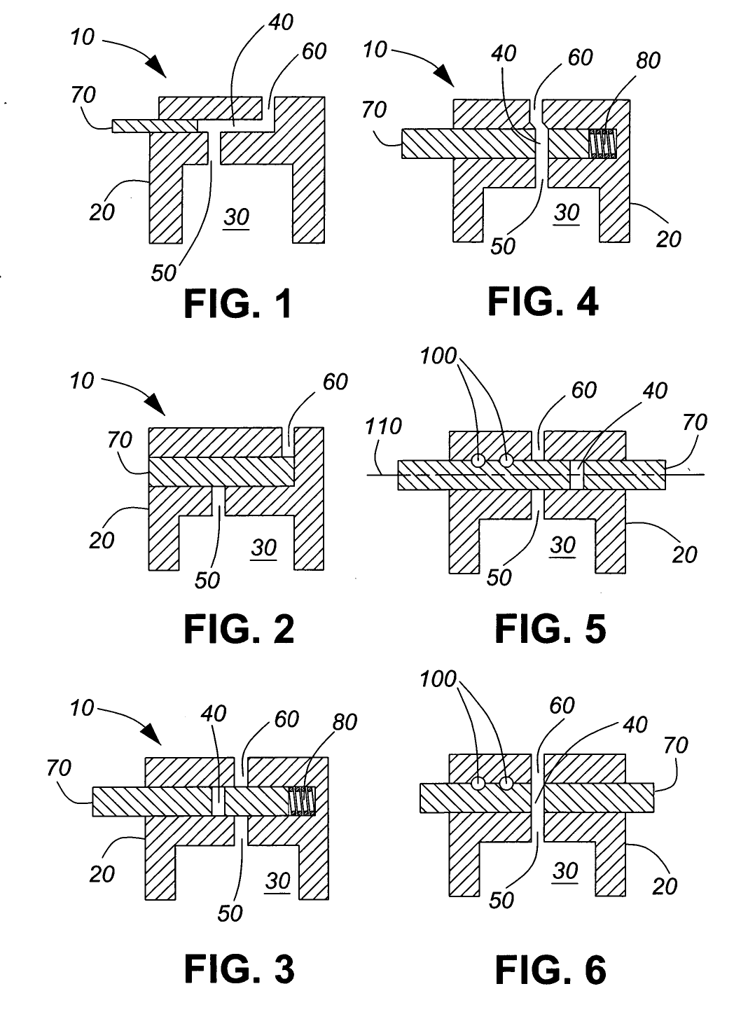

Referring to FIG. 1, a side cut away view of a device according to one aspect of the invention is illustrated. The acoustically shielding device 10 has a body 20 in which there is an interior cavity 30. A bore 40 is also present on the body 20 and is adjacent to the interior cavity 30. Also in the body 20 are a first passage 50 and a second passage 60. A plug 70 is movable inside the bore 40. The first passage 50 allows air to travel between the interior cavity 30 and the bore 40 while the second passage 60 allows air to travel between the bore 40 and the exterior of the device. The plug 70 has an open position and a closed position. When in the open position, the plug 70 allows air to travel between the interior cavity 30 and the exterior by way of the first passage 50 and the second passage 60. In the open position, the first and second passage 50, 60 may be seen as two parts of a single air passage between the interior cavity and the exterior. The plug 70 is shown in the open position in FIG. 1.

Referring to FIG. 2, the device 10 is shown in a side cutaway view with the plug 70 in the closed position. As can be seen, in the closed position, the plug 70 occludes both (or at least one of) the first and second passages 50, 60 and thereby prevents air from traveling between the interior cavity and the exterior. It should be noted that the plug 70 fits snugly in the bore 40 so as to prevent, as much as possible, air from entering the interior cavity 30 by way of the second passage 60 when the plug is in the closed position.

Referring to FIG. 3, another embodiment of the invention is illustrated. In this embodiment, a spring 80 is in the bore 40. The spring 80 serves to keep the plug 70 in the closed position as the plug 70 has a corresponding passage 90 which, when aligned with the first and second passages 50, 60, creates an air passage. The air passage allows air to travel between the interior cavity to the exterior of the device. Depending on the configuration of the plug and of the device as a whole, the closed position may be the default position of the plug. For this embodiment, the plug 70 is kept in the closed position as the spring 80, in a relaxed state, ensures that the passage 80 is not aligned with the first and second passages 50, 60. However, upon actuation of the plug 70, (i.e. causing compression of the spring 80), the corresponding passage 90 aligns with the first and second passages 50, 60. This open position is illustrated in FIG. 4.

Another embodiment is illustrated in FIGS. 5 and 6. FIG. 5 illustrates the closed position while FIG. 6 illustrates the open position. In this embodiment, the plug 70 is actuated by moving it between two preset and predetermined positions. A detent means 100, such as a roller ball and matching notches system on the plug 70 and on the body 20 keeps the plug 70 in either the open or closed position. A user actuates the plug 70 by moving it in a direction parallel to the longitudinal axis 110 of the bore 40. This can be done by merely pushing the plug 70 in the relevant direction. Once the pushing force unseats the roller ball from its notch, the plug can travel until the roller ball catches the other notch.

It should be noted that, as can be seen from FIGS. 1-6, different configurations for the first and second passages and for the bore are possible. In FIGS. 1-4, the bore 40 does not tunnel through or go all the way through the body 20. However, in FIGS. 5 and 6, the bore tunnels through the body 20 to accommodate the configuration of the plug 70. As can also be seen in FIGS. I and 2, the first and second passages 50, 60 are not aligned with one another whereas in FIGS. 3-6, they are aligned. The plug 70 may also have numerous configurations depending on the implementation details regarding the first and second passages. In FIGS. 1 and 2, the plug 70 is a relatively solid piece while in FIGS. 3-6, the plug 70 has a void or channel 90 to provide the corresponding passage between the first and second passages.

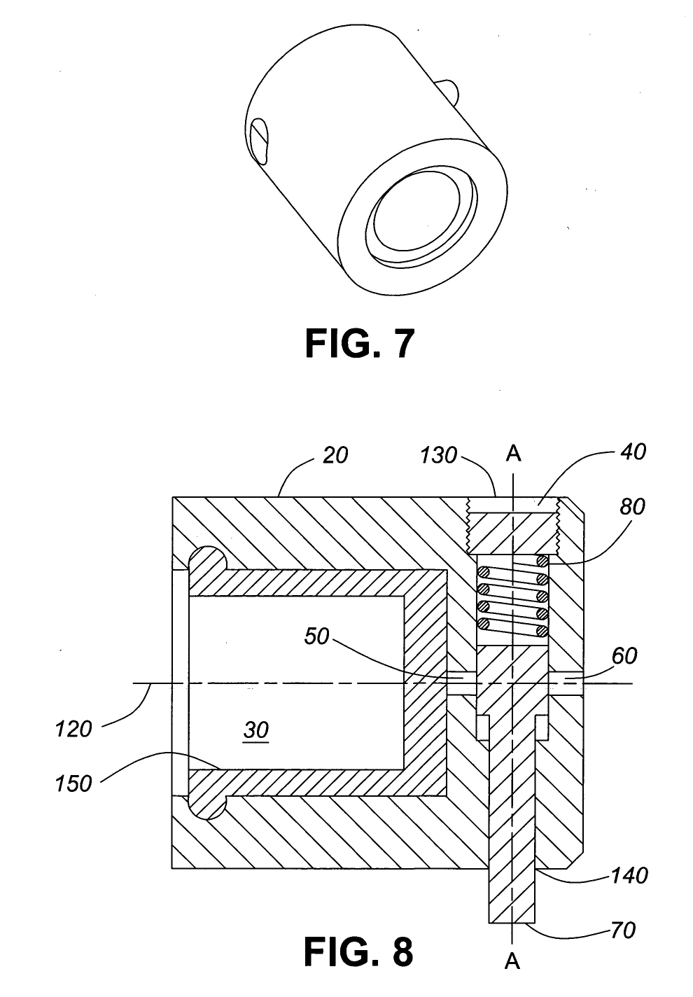

Referring to FIG. 7, an isometric view of an exemplary embodiment of the invention is illustrated. In FIG. 8, a cut away view of this embodiment is illustrated. As can be seen, the bore 40 tunnels through the body 20 of the device 10 and the first and second passages 50, 60 are aligned with one another and with the longitudinal axis 120 of the interior cavity 30. The bore 40 has a larger end 130 and a smaller end 140. The plug 70 is variably sized such that one end fits snugly in the smaller end 140 while the other end is accommodated by the larger end 130. The bore is sized variably as well so that the plug 70 cannot be removed by way of the smaller end 140. A spring 80 is disposed in the larger end of the bore 40 and, in its relaxed state, the spring urges the plug 70 such that the body of the plug occludes the first and second passages. However, when the portion of the plug protruding from the smaller end is pushed towards the larger end of the bore, compression is caused on the spring and an air passage, by way of the bore, is created such that air can travel between the interior cavity 30 and the exterior through the first and second passages. An O-ring may also be used to seal the larger end of the bore. Depending on where the spring is positioned, actuation of the plug may cause compression or extension of the spring.

It should be noted that, as can be seen in FIG. 8, it is preferable that the bore be intersecting with and transverse to the longitudinal axis 120 of the interior cavity and that the bore is non-intersecting with the interior cavity.

While the above embodiments contemplate using detent systems and spring means to keep the plug in the close position, other systems are also possible. In another embodiment, the plug and the bore are matingly threaded such that the plug is rotatable in the bore - rotating the plug results in a screw-like action which causes the plug to move up or down the bore. This causes the first and second passages to, depending on the direction of the plug's movement, be opened or be occluded. A void, channel, or passage in the plug may be aligned with the first and second passages due to the plug movement, thereby creating the air passage mentioned above. Alternatively to the void, channel, or passage in the plug, the threading may be configured such that gaps between the threads open and close depending on the direction of the plug's movement. These gaps would provide the corresponding passage through which air can travel.

Concerning construction of the device, the body and the plug can be made from any non-magnetic and electrically non-conducting material that is also acoustically shielding or isolating. However, it has been found that the performance of the device improves if the device were constructed out of a material which has an acoustic isolative property over a broad frequency range such as between 200 Hz to 20,000 Hz. The body can be made from a single material or from multiple layers of one or more materials. If one material is used, the material can have variable acoustic properties across its thickness. Examples of material which may be used are fiberglass, rubber, soft plastic, neoprene, and delrin.

The first and second passages can be situated anywhere along the bore and should be sized to allow sufficient air to escape so that no sudden build-up of air pressure occurs when the microphone is inserted or removed from the interior cavity. The diameter of the first and second passages may be anywhere from 0.5 mm to 2 mm or larger. The placement of the first and second passages should allow for substantially all the air displaced by the insertion of the microphone into the interior cavity to escape to the exterior when the plug is in the open position.

To provide durability to the device, an inner lining may be provided inside the interior cavity. Such a lining 150 is illustrated in FIG. 8. The inner lining may be configured such that its interior surface adheres to the entire surface of the sound receptor or microphone. Ideally, the inner lining is configured such that neither the sound receptor nor the device is damaged by repeated insertion or removal of the microphone from the interior cavity.

To utilize the device, a user actuates the plug to transition the plug from the closed position to the open position. Once the plug is in the open position, the microphone or sound receptor is then inserted into the interior cavity. The insertion of the microphone into the interior cavity will displace air from the interior cavity to the exterior by way of the air passage created by the plug in the open position. As noted above, the air passage consists of the first and second passages and a further passage provided by either the bore or a void or channel through the plug or beside the plug (as in the threaded embodiment above). Once the microphone has been inserted, the plug can then be further actuated (or released) to transition from the open position to the closed position. Once the plug is in the closed position, the microphone is then acoustically shielded or isolated.

To remove the microphone from the device, the user actuates the plug to place it in the open position. The microphone is then removed from the interior cavity. With the plug in the open position, a sudden and possibly damaging (to the microphone) build up of air pressure is prevented.

A person understanding this invention may now conceive of alternative structures and embodiments or variations of the above all of which are intended to fall within the scope of the invention as defined in the claims that follow.

What is claimed is:

1. An acoustically shielding device for a sound level meter having a microphone, the device comprising:
a body having an interior cavity and an exterior, said interior cavity being for snugly enveloping said microphone;
a bore in said body, said bore being adjacent to said interior cavity, said bore being non-intersecting with said interior cavity;
a first passage in said body for allowing air to travel between said exterior of said body and said bore;
a second passage in said body for allowing air to travel between said interior cavity and said bore; and
a plug snugly fitting in said bore, said plug having an open position and a closed position;
wherein, in said open position, said plug allows air to travel between said interior cavity and said exterior of said body by way of said first and second passages; and
wherein, in said closed position, said plug prevents air from traveling between said interior cavity and said exterior of said body.

2. The device according to claim 1, wherein said bore intersects and is transverse to a longitudinal axis of said interior cavity.

3. The device according to claim 1, wherein said plug is movable in said bore in a direction parallel to a longitudinal axis of said bore to transition said plug between said first and said second positions.

4. The device according to claim 3, further comprising spring means for returning said plug to a default position after said plug is moved.

5. The device according to claim 4, wherein said default position is said closed position.

6. The device according to claim 1, wherein said bore tunnels through said body.

7. The device according to claim 1, wherein said plug occludes at least one of said passages when said plug is in said closed position.

8. The device according to claim 3, wherein said bore and said plug are matingly threaded such that said plug screws into said bore.

9. The device according to claim 1, wherein, in said open position, air travels between said first and second passages by way of a further passage in said bore by way of said plug.

10. The device according to claim 9, wherein said further passage is a channel in said plug which aligns with said first and said second passages when said plug is in said open position.

11. The device according to claim 9, wherein said further passages are provided by gaps between mating threads on said bore and said plug such that said gaps are closed when said plug is in said closed position and said gaps are open when said plug is in said open position.

12. The device according to claim 6, wherein said bore comprises a larger end and a smaller end, said bore being variably sized to prevent said plug from being removed from said bore through said smaller end.

13. The device according to claim 12, wherein said larger end is sealed by an O-ring and said smaller end is sealed by said plug.

14. A method of acoustically shielding a sound receptor of a sound level meter, the method comprising:
a) providing an acoustically shielding device having an interior cavity;
b) actuating a plug on said device to create an air passage between said interior cavity and an exterior of said device;
c) inserting said sound receptor into said interior cavity and allowing air to escape from said interior cavity to said exterior by way of said air passage created in step b); and
d) closing said air passage to thereby acoustically seal said sound receptor in said interior cavity.

15. The method according to claim 14, wherein step d) is accomplished by further actuating said plug to occlude said air passage.

16. The method according to claim 14, wherein step b) causes flexion of a spring means.

17. The method according to claim 14, wherein step b) moves said plug along a bore in said device.

18. The method according to claim 14, wherein step d) allows said plug to return to a default position.
